(19) United States
(12) Patent Application Publication
(10) Pub. No.: US 2024/0327225 A1
(43) Pub. Date: Oct. 3, 2024

(54) PROCESSES FOR PREPARING CARBON SOURCES FOR ACTIVATION AND FOR ACTIVATING CARBON

(71) Applicant: CARBONIX INC., FORT WILLIAM FIRST NATION (CA)

(72) Inventors: PAUL RAIVO PEDE, PETERBOROUGH (CA); ANDREW JAMES VREUGDENHIL, PETERBOROUGH (CA); OLIVER STRONG, PETERBOROUGH (CA); COLE JEFFERY DENNIS, PETERBOROUGH (CA)

(73) Assignee: CARBONIX INC., FORT WILLIAM FIRST NATION, ON (CA)

(21) Appl. No.: 18/579,936

(22) PCT Filed: Jul. 26, 2022
(86) PCT No.: PCT/CA2022/051148

§ 371 Date: Jan. 17, 2024

Related U.S. Application Data
(60) Provisional application No. 63/226,370, filed on Jul. 28, 2021.

(51) Int. Cl. C01B 32/33

(52) U.S. Cl. CPC C01B 32/33; C01P 2006/17

(57) ABSTRACT

A process for preparing activated carbon includes combining crushed petroleum coke (petcoke) with non-aqueous potassium hydroxide. The petcoke and the potassium hydroxide are then heated to a sub-activation temperature to yield a pre-activated blend. Under substantially inert conditions, the preactivated blend is then heated to at least the activation temperature of the petcoke to yield a first-stage activated blend. The first-stage activated blend includes activated carbon of a first microporosity percentage. The first-stage activated blend is then cooled to below the activation temperature of the petcoke. Under substantially inert conditions, the first-stage activated blend is then re-heated to at least the activation temperature of the petcoke to yield a second-stage activated blend. The second-stage activated blend includes activated carbon of a second microporosity percentage that is less than the first microporosity percentage. The steps of cooling and reheating may be repeated serially, to tailor the microporosity of the activated carbon.

### CROSS-REFERENCES TO RELATED APPLICATIONS

This application claims priority to and/or the benefit of U.S. Provisional Patent Application No. 63/226,370 filed on Jul. 28, 2021, which is incorporated herein by reference in its entirety.

### FIELD

This document relates to activated carbon. More specifically, this document relates to processes for preparing carbon for activation, processes for activating carbon, and related products.

### BACKGROUND

U.S. Pat. No. 5,401,472 (Kawakami et al.) discloses an apparatus for producing high surface area active carbons by an alkali metal hydroxide-based activation method.

U.S. Pat. No. 7,232,790 (Tanaka et al.) discloses a method for producing an activated carbon material. The method includes a step of thermally treating coal-based pitch at two temperature ranges of 400° C. to 600° C. and 600° C. to 900° C., and a step of mixing the thus obtained carbonaceous material with an alkali metal compound and effecting activation thereof at 600° C. to 900° C. An activated carbon material obtained by the method is further disclosed.

U.S. Pat. No. 8,563,467 (Hashisho et al.) discloses a method of preparing activated carbon including exposing carbonaceous material to microwave radiation in the presence of water to produce activated carbon.

### SUMMARY

The following summary is intended to introduce the reader to various aspects of the detailed description, but not to define or delimit any invention.

Processes for preparing carbon sources for activation are disclosed. According to some aspects, a process for preparing a carbon source for activation includes: a. combining a crushed carbonized carbon source with an alkali hydroxide, wherein the alkali hydroxide is in a non-aqueous state; and b. heating the crushed carbonized carbon source and the alkali hydroxide to a sub-activation temperature to yield a pre-activated blend, wherein the sub-activation temperature is at or above a melting point of the alkali hydroxide and below an activation temperature of the crushed carbonized carbon source.

In some examples, the crushed carbonized carbon source has a particle size of at most 8 mesh.

In some examples, the crushed carbonized carbon source includes at least one of a petroleum coke, a lignite coal, an anthracite coal, a metallurgical coal, and a bottom boiler ash.

In some examples, the crushed carbonized carbon source includes or is petroleum coke.

In some examples, the alkali hydroxide includes or is potassium hydroxide.

In some examples, in step a., the alkali hydroxide is in the form of potassium hydroxide pellets.

In some examples, the sub-activation temperature is between 360 degrees Celsius and 750 degrees Celsius.

In some examples, step b. is carried out under ambient air and the sub-activation temperature is between 360 degrees Celsius and 550 degrees Celsius.

In some examples, in step b., the sub-activation temperature is maintained for a retention time of at least 15 minutes.

In some examples, in step b., the sub-activation temperature is maintained for a retention time of between 15 minutes and 30 minutes.

In some examples, the crushed carbonized carbon source and the alkali hydroxide are combined in a mass ratio of between 0.5:1 and 3:1 alkali hydroxide:crushed carbonized carbon source.

In some examples, the crushed carbonized carbon source and the alkali hydroxide are combined in a mass ratio of about 1:1 alkali hydroxide:crushed carbonized carbon source.

The crushed carbonized carbon source may have a particle size of at most 8 mesh.

The crushed carbonized carbon source may include at least one of a petroleum coke, a lignite coal, an anthracite coal, a metallurgical coal, and a bottom boiler ash.

The crushed carbonized carbon source may include petroleum coke.

The alkali hydroxide may include or be potassium hydroxide.

The alkali hydroxide may be in the form of potassium hydroxide pellets.

The sub-activation temperature may be between 360 degrees Celsius and 750 degrees Celsius.

Step b. may be carried out under ambient air and the sub-activation temperature may be between 360 degrees Celsius and 550 degrees Celsius.

In step b., the sub-activation temperature may be maintained for a retention time of at least 15 minutes.

In step b., the sub-activation temperature may be maintained for a retention time of between 15 minutes and 30 minutes.

The crushed carbonized carbon source and the alkali hydroxide may be combined in a mass ratio of between 0.5:1 and 3:1 alkali hydroxide:crushed carbonized carbon source.

The crushed carbonized carbon source and the alkali hydroxide may be combined in a mass ratio of about 1:1 alkali hydroxide:crushed carbonized carbon source.

A product may be made by the process of any one or more claims, clauses, embodiments or examples herein, or combinations thereof.

Processes for activating carbon are also disclosed. According to some aspects, a process for activating carbon includes: a. under substantially inert conditions, heating a blend of a crushed carbonized carbon source and a non-aqueous alkali hydroxide product to at least an activation temperature of the crushed carbonized carbon source, to yield a first-stage activated blend, wherein the first stage activated blend includes activated carbon of a first microporosity percentage; b. after step a., cooling the first stage activated blend to below the activation temperature of the crushed carbonized carbon source; c. after step b., under substantially inert conditions, heating the first stage activated blend to at least the activation temperature of the crushed carbonized carbon source to yield a second-stage activated blend, wherein the second stage activated blend includes activated carbon of a second microporosity percentage that is less than the first microporosity percentage.

In some examples, after step c., the method further includes washing the second-stage activated blend.

In some examples, the method further includes cooling the second stage activated blend to below the activation temperature of the crushed carbonized carbon source. The method may further include, after step d., under substantially inert conditions, heating the second stage activated blend to at least the activation temperature of the crushed carbonized carbon source to yield a third-stage activated blend, wherein the third stage activated blend includes activated carbon of a third microporosity percentage that is less than the second microporosity percentage.

In some examples, step a. is carried out under nitrogen gas. In step a., oxygen may be bled into the nitrogen gas.

In some examples, in step b., the first stage activated blend is cooled to below a combustion temperature of the crushed carbonized carbon source. Step b. may further include, after cooling the first stage activated blend to below the combustion temperature of the crushed carbonized carbon source, exposing the first stage activated blend to ambient air.

In some examples, the first stage activated blend is maintained below the combustion temperature of the crushed carbonized carbon source and exposed to air for up to 72 hours.

In some examples, in step b., the first stage activated blend is cooled to between 200 degrees Celsius and 250 degrees Celsius.

In some examples, in step a., the crushed carbonized carbon source and the non-aqueous alkali hydroxide product are maintained at at least the activation temperature for between 7 minutes and 60 minutes.

In some examples, in step a., the crushed carbonized carbon source and the non-aqueous alkali hydroxide product are maintained at at least the activation temperature for between 7 minutes and 30 minutes.

In some examples, in step c., the first stage activated blend is maintained at at least the activation temperature for between 7 minutes and 30 minutes.

In some examples, in step a., the crushed carbonized carbon source and the non-aqueous alkali hydroxide product are heated to between 750 degrees Celsius and 900 degrees Celsius.

In some examples, prior to step a., the method further includes: combining the crushed carbonized carbon source with an alkali hydroxide, wherein the alkali hydroxide is in a non-aqueous state; and heating the crushed carbonized carbon source and the alkali hydroxide to a sub-activation temperature to yield a pre-activated blend, wherein the sub-activation temperature is at or above a melting point of the alkali hydroxide and below an activation temperature of the crushed carbonized carbon source, and wherein the pre-activated blend includes the crushed carbonized carbon source and the alkali hydroxide product.

After step c., the process may include washing the second-stage activated blend.

The process may further include: d. cooling the second stage activated blend to below the activation temperature of the crushed carbonized carbon source.

The process may further include: e. after step d., under substantially inert conditions, heating the second stage activated blend to at least the activation temperature of the crushed carbonized carbon source to yield a third-stage activated blend, wherein the third stage activated blend comprises activated carbon of a third microporosity percentage that is less than the second microporosity percentage.

Step a. may be carried out under nitrogen gas.

In step a., oxygen may be bled into the nitrogen gas.

In step b., the first stage activated blend may be cooled to below a combustion temperature of the crushed carbonized carbon source.

Step b. may further include, after cooling the first stage activated blend to below the combustion temperature of the crushed carbonized carbon source, exposing the first stage activated blend to ambient air.

The first stage activated blend may be maintained below the combustion temperature of the crushed carbonized carbon source and exposed to air for up to 72 hours.

In step b., the first stage activated blend may be cooled to between 200 degrees Celsius and 250 degrees Celsius.

In step a., the crushed carbonized carbon source and the non-aqueous alkali hydroxide product may be maintained at at least the activation temperature for between 7 minutes and 60 minutes.

In step a., the crushed carbonized carbon source and the non-aqueous alkali hydroxide product may be maintained at at least the activation temperature for between 7 minutes and 30 minutes.

In step c., the first stage activated blend may be maintained at at least the activation temperature for between 7 minutes and 30 minutes.

In step a., the crushed carbonized carbon source and the non-aqueous alkali hydroxide product may be heated to between 750 degrees Celsius and 900 degrees Celsius.

The process may further comprise, prior to step a.: i. combining the crushed carbonized carbon source with an alkali hydroxide, wherein the alkali hydroxide is in a non-aqueous state; and ii. heating the crushed carbonized carbon source and the alkali hydroxide to a sub-activation temperature to yield a pre-activated blend, wherein the sub-activation temperature is at or above a melting point of the alkali hydroxide and below an activation temperature of the crushed carbonized carbon source, and wherein the pre-activated blend comprises the crushed carbonized carbon source and the alkali hydroxide product.

Processes for preparing and activating carbon are also disclosed. According to some aspects, a process for preparing and activating carbon includes: a. combining crushed petroleum coke with potassium hydroxide, wherein the potassium hydroxide is in a non-aqueous state; b. after step a., heating the crushed petroleum coke and the potassium hydroxide to a sub-activation temperature to yield a pre-activated blend, wherein the sub-activation temperature is at or above a melting point of the potassium hydroxide and below an activation temperature of the crushed carbonized carbon source; c. after step b., under substantially inert conditions, heating the pre-activated blend to at least the activation temperature of the crushed carbonized carbon source to yield a first-stage activated blend, wherein the first stage activated blend includes activated carbon of a first microporosity percentage; d. after step c., cooling the first stage activated blend to below the activation temperature of the crushed carbonized carbon source; and e. after step d., under substantially inert conditions, heating the first stage activated blend to at least the activation temperature of the crushed carbonized carbon source to yield a second-stage activated blend, wherein the second stage activated blend includes activated carbon of a second microporosity percentage that is less than the first microporosity percentage.

A product may be made by the process of any claims, clauses, embodiments or examples herein may be used to remove organic carbon from water.

A product may be made by the process of any claims, clauses, embodiments or examples herein may be used to remove organic carbon from at least one fluid.

The at least one fluid may include at least one liquid, gas, or liquified gas.

The at least one fluid may be an effluent, or a stream including a waste stream, supply stream and/or another stream.

Uses for the products made by the processes disclosed herein are also disclosed. According to some aspects, the products made by the processes disclosed herein may be used in the removal of organic carbon from fluids, such as water or other fluids, such as fluid effluents or waste streams or other streams. Such fluids may include liquids, gases, liquified gases, or the like.

A product made by the process of any claims, clauses, embodiments or examples herein may be used to remove at least one acid gas from at least one raw natural gas stream.

The at least one acid gas may include hydrogen sulfide and/or carbon dioxide.

### BRIEF DESCRIPTION OF THE DRAWINGS

The drawings included herewith are for illustrating various examples of articles, methods, and apparatuses of the present specification and are not intended to limit the scope of what is taught in any way. In the drawings:

FIG. 1 is a flowchart of an example process for preparing and activating carbon;

FIG. 2 is a graph showing the incremental pore size distribution of activated carbon samples activated at a ratio of 1:1 KOH:petroleum coke, going through 1, 2 and 3 activation stages to 900° C.;

FIG. 3 is a graph showing the surface area and percent microporosity of activated carbon produced at a ratio of 1:1 KOH:petroleum coke in a single activation stage with increasing retention time;

FIG. 4 is a graph showing the surface area and percent microporosity of activated carbon produced at a ratio of 1:1 KOH:petroleum coke, in a single activation stage of 900° C. for 15 minutes, two activation stages at 900° C. for 15 minutes each, with a wash between activation steps, and two activation stages at 900° C. for 15 minutes each, with no wash between activation stages;

FIG. 5A is a graph showing the relationship between the ratio of KOH to petroleum coke (PC), the number of activation stages, and the percent mesoporosity;

FIG. 5B is a graph showing the relationship between the ratio of KOH to petroleum coke (PC), the number of activation stages, and surface area;

FIG. 6 is a graph showing the adsorption kinetics of diphenyl acetic acid (DPA) over time onto single-, double- and triple-activated carbon;

FIG. 7 is a graph showing adsorption kinetic curves of DPA onto single-, double- and triple-activated carbon, normalized based on mg/g

FIG. 8 is a graph showing adsorption kinetic curves of DPA onto single-, double- and triple-activated carbon, normalized based on adsorption; and

FIG. 9 is a graph showing the ratio of the fitted D to G peak areas from the Raman spectrum of an activated carbon sample;

FIG. 10 is a graph showing the % removal of organic carbon from oil sands process water using single- and triple-activated carbon; and

FIG. 11 is a graph showing the % removal of organic carbon from oil sands process water using triple-activated carbon of different sizes.

### DETAILED DESCRIPTION

Various apparatuses or processes or compositions will be described below to provide an example of an embodiment of the claimed subject matter. No embodiment described below limits any claim and any claim may cover processes or apparatuses or compositions that differ from those described below. The claims are not limited to apparatuses or processes or compositions having all of the features of any one apparatus or process or composition described below or to features common to multiple or all of the apparatuses or processes or compositions described below. It is possible that an apparatus or process or composition described below is not an embodiment of any exclusive right granted by issuance of this patent application. Any subject matter described below and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

As used herein, the term “carbonized carbon source” refers to a carbon source that has previously been carbonized, for example in a previous process step, or as the source exists in a natural state. Non-limiting examples of carbonized carbon sources include petroleum coke (also called petcoke), lignite coals, anthracite coals, metallurgical coals, bottom boiler ash, asphaltene, and combinations thereof.

As used herein, the term “alkali hydroxide” refers to sodium hydroxide, potassium hydroxide, lithium hydroxide, or a combination thereof.

As used herein, the term “alkali hydroxide product” refers to an alkali hydroxide and/or a direct or indirect reaction product thereof. For example, the term “alkali hydroxide product” may refer to (but is not limited to) potassium hydroxide, the potassium oxide that is formed when potassium hydroxide is decomposed in the preparation process disclosed herein, the pure potassium that is formed when potassium oxide reacts with carbon in the activation process disclosed herein, the potassium carbonate that is formed when potassium oxide reacts with carbon dioxide in the activation process disclosed herein, the pure potassium that is formed when potassium carbonate reacts with carbon in the activation process disclosed herein, and/or combinations thereof.

As used herein, the terms “non-aqueous” refers to a product that is not in aqueous solution. For example, the term “non-aqueous alkali hydroxide” may refer to an alkali hydroxide that is in solid form (e.g. pellets, crushed pellets, powder, or rods) or in a melt state. For greater clarity, the term “non-aqueous alkali hydroxide” includes alkali hydroxides that have adsorbed or absorbed water due to hygroscopicity. For example, potassium hydroxide pellets, which are considered to be a non-aqueous alkali hydroxide, may often contain about 10% water. In this document, the term “alkali hydroxide in a non-aqueous state” is interchangeable with term “non-aqueous alkali hydroxide”

As used herein, the term “micropore” (and related terms such as “microporous” “microporosity”) refers to pores that have a diameter of less than about 2 nm. The term “mesopore” (and related terms such as “mesoporous” and “mesoporosity”) refers to pores that have a diameter of between about 2 to about 50 nm. The terms “microporosity percentage” or “percent microporosity” refer to the number of a pores in a sample that are microporous, as percentage of the total number of pores in the sample. The terms “mesoporosity percentage” or “percent mesoporosity” refer to the number of pores in a sample that are mesoporous, as percentage of the total number of pores in the sample.

As used herein, the term “about” indicates that a referenced value may vary by plus or minus 5%. For example, a reference to a temperature of “about 800 degrees Celsius” indicates that the temperature may be between 760 degrees Celsius and 840 degrees Celsius.

In this document, unless specified otherwise, all ranges are inclusive of the bounds of the range. For example, the statement that a temperature may be “between 750 degrees Celsius and 900 degrees Celsius” indicates that the temperature may be 750 degrees Celsius, or 900 degrees Celsius, or any number therebetween.

In any instance in which the disclosure refers to a single instance of an element, examples may include a multiple of such elements. The term “at least one” in reference to any element is not intended to force an interpretation on any other reference elsewhere in the disclosure to a single instance of an element to mean only one such instance of the element.

Generally disclosed herein is a process for preparing and activating carbon. The process may generally include at least two sub-processes, namely: a preparation process, in which a carbon source is prepared for activation, and an activation process, in which a carbon source is activated. In general, in this document, these two sub-processes will be described as being carried out in sequence as part of a single overall process for preparing and activating carbon (i.e. as part of a single overall process in which a carbon source is prepared for activation, and then the prepared carbon source is activated). However, the two sub-processes may be carried out independently (i.e. the prepared carbon source may be further processed according to methods other than the activation process disclosed herein, and the feed to the activation process may include carbon sources other than the prepared carbon source).

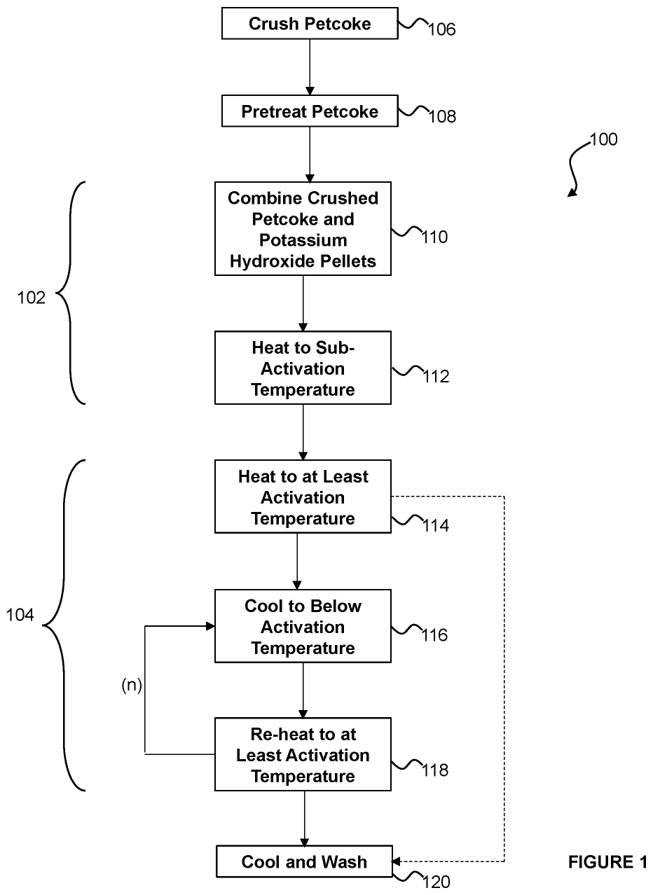

Referring now to FIG. 1, an example process 100 for preparing and activating carbon is shown. As mentioned above, the process includes two sub-processes, namely a preparation process 102, and an activation process 104.

In the example shown, the feedstock to the preparation process 102 includes crushed petcoke as a carbonized carbon source, as well as potassium hydroxide pellets as a non-aqueous alkali hydroxide. However, as noted above, in alternative examples, the feedstock may include another carbonized carbon source and/or another non-aqueous alkali hydroxide.

The crushed petcoke may have a particle size of, for example, at most about 8 mesh, and will generally include a mixture of larger particles (i.e. particles that may be described as granules, which may have a particle diameter of up to about 2380 microns) and smaller particles (i.e. particles that may be described as a fines, which may have a particle diameter of about 44 microns). By using a mixture of particle sizes in the feedstock, an end product (i.e. activated carbon) of mixed particle size is produced. This end product may then optionally be sieved to sort it by particle size, so that different particle sizes are available to be used or sold.

The crushed petcoke may optionally be obtained in crushed form and fed to the preparation process; however, in the example shown, the process includes a step of crushing the petcoke (step 106). Crushing the petcoke may be achieved by using a cone crusher or similar device. The crushing may be done in a single pass or through a staged process.

Optionally, the crushed petcoke may be pre-treated by heating it at about 400 degrees Celsius under air for about 1 hour, in order to remove water and any volatile compounds (step 108).

At step 110, the crushed petcoke and potassium hydroxide pellets are combined, for example in a rotary calciner. Because the process as shown uses non-aqueous potassium hydroxide, a relatively small amount of potassium hydroxide may be used, as the contact area of the potassium hydroxide and the carbon source is relatively high. For example, the potassium hydroxide and crushed petcoke may be combined in a mass ratio of between about 0.5:1 and about 3:1, KOH:petcoke (e.g. 0.5:1, or 0.75:1, or 1:1, or 2:1, or 3:1 KOH:petcoke).

At step 112, the crushed petcoke and potassium hydroxide pellets are heated to a sub-activation temperature that is at or above a melting point of the potassium hydroxide, but below an activation temperature of the crushed petcoke. The sub-activation temperature may be, for example, between about 360 degrees Celsius and about 750 degrees Celsius (e.g. about 400 degrees Celsius). If the sub-activation temperature is below the combustion temperature of the petcoke (e.g. below about 550 degrees Celsius), then step 112 may optionally be carried out under air. If the sub-activation temperature is above the combustion temperature of the petcoke, then step 112 may be carried out in an inert environment (e.g. under nitrogen or another inert gas).

Optionally, the crushed petcoke and potassium hydroxide pellets may be mixed during step 112.

At the sub-activation temperature, the potassium hydroxide pellets melt to coat the crushed petcoke and form an agglomerate with the crushed petcoke; however, activation of the carbon (i.e. reaction of the carbon with the potassium hydroxide or a product thereof to form pores in the carbon) generally does not occur. That is, activation of the carbon does not occur, or occurs only in a negligible or non-substantial amount. It is believed that at the sub-activation temperature, at least some of the potassium hydroxide is converted to potassium oxide according to the following reaction:

2KOH→K₂O+H₂O(g) (Reaction I)

The sub-activation temperature may be maintained for a retention time of, for example, at least about 15 minutes (e.g. about 30 minutes).

The product of step 112 is referred to herein as a “pre-activated blend”, and may generally include an agglomerate of non-aqueous potassium hydroxide products (e.g. melted potassium hydroxide and potassium oxide), and the crushed petcoke.

At step 114, the pre-activated blend is heated to at least the activation temperature of the petcoke, under substantially inert conditions. For example, the pre-activated blend may be heated to between about 750 degrees Celsius and about 900 degrees Celsius (e.g. about 800 degrees Celsius). This temperature may be maintained for a retention time of between about 7 minutes and about 60 minutes, or between about 7 minutes and about 30 minutes, or about 15 minutes. Optionally, step 114 may be carried out with mixing, for example in a rotary calciner.

At or above the activation temperature, it is believed that the following reactions occur, resulting in the activation of the petcoke:

K₂O+C(s)→2K+CO(g) (Reaction II)

K₂O+CO₂(g)→K₂CO₃ (Reaction III)

K₂CO₃+2C(s)→2K+3CO(g) (Reaction IV)

In Reaction III, it is believed that carbon dioxide is present due to thermal decomposition of surface oxidation sites on the petcoke.

It further is believed that the following additional reactions may occur with any water that remains in the system:

2K+H₂O→H₂+2KOH (Reaction V)

2K+CO₂+H₂O→K₂CO₃+H₂ (Reaction VI)

As mentioned above, step 114 is carried out under substantially inert conditions. The term “substantially inert conditions” indicates that conditions are maintained such that extensive combustion does not occur. For example, step 114 may be carried out under an inert gas such as nitrogen. However, it is possible that a small amount of oxygen (e.g. so that the reaction environment is between about 0.1% and about 0.3% oxygen, by mass) may be bled into the system, to promote a small and controlled amount of combustion. This small and controlled amount of combustion may supply heat to step 114, so that step 114 is effectively self heated.

Step 114 may also be referred to as a “first activation stage”, and the product of step 114 may be referred to herein as a “first stage activated blend”. The first stage activated blend may generally include activated carbon, potassium hydroxide products, and other reaction by-products. It has been found that the activated carbon that results from step 114 has a microporosity percentage (also referred to herein as a “first microporosity percentage”) of between about 45% and about 80% (e.g. about 75%), with the remaining pores being mesoporous.

Optionally, the activation process 104 may end after step 114, and the first stage activated blend may be sent to downstream processing steps (e.g. cool and wash step 120) to yield activated carbon (also referred to herein as single-activated carbon); however, it has been determined that serially cooling and reheating the reaction products (i.e. cooling the first stage activated blend and reheating the first stage activated blend to yield a second stage activated blend, cooling the second stage activated blend and reheating the second stage activated blend to yield a third-stage activated blend, and so on) may allow for the porosity of the activated carbon to be tailored. For example, cooling the first stage activated blend and reheating the first stage activated blend to yield a second stage activated blend may result in an activated carbon that has a microporosity percentage (referred to herein as a “second microporosity percentage”) that is less than the first microporosity percentage (e.g. of between about 65% and about 35%, for example about 60%, with the remaining pores being mesoporous). Cooling the second stage activated blend and reheating the second stage activated blend to yield a third stage activated blend may result in an activated carbon that has a microporosity percentage (referred to herein as a “third microporosity percentage”) that is less than the second microporosity percentage (e.g. of between about 20% and about 40%, for example about 35%, with the remaining pores being mesoporous). Accordingly, the reaction products may optionally be serially cooled and reheated, in order to obtain a more mesoporous activated carbon.

Accordingly, after step 114, the activation process may optionally further include a second activation stage, which involves cooling the first stage activated blend to below the activation temperature of the petcoke (step 116) and reheating the first stage activated blend to at least the activation temperature of the petcoke (step 118).

In step 116, the first stage activated blend is preferably cooled to below the combustion temperature of the petcoke, for example to below about 550 degrees Celsius (e.g., between about 200 degrees Celsius and about 250 degrees Celsius), and is exposed to air. The first stage activated blend may be maintained at this temperature and exposed to air for a matter of minutes, or for up to about 72 hours, or may immediately be reheated without any substantial retention time. It is believed that by exposing the first stage activated blend to air, some of the potassium reacts with humidity in the air and is converted back to potassium hydroxide and potassium carbonate, according to Reactions V and VI, which makes potassium hydroxide and potassium carbonate available for further activation of the carbon in the subsequent re-heating step.

At step 118, as mentioned above, the first stage activated blend is re-heated to at least the activation temperature of the petcoke, again under substantially inert conditions. For example, the first-stage activated blend may be heated to between about 750 degrees Celsius and about 900 degrees Celsius (e.g. about 800 degrees Celsius). This temperature may be maintained for a retention time of between about 7 minutes and about 60 minutes, or between about 7 minutes and about 30 minutes, or about 10 to 12 minutes. At or above the activation temperature, it is believed that Reactions I to IV again occur. Step 118 results in further activation, which is believed to involve widening of the pores that were created in step 114. Optionally, the first stage activated blend may first be reheated to the sub-activation temperature and held at the sub-activation temperature for a retention time, and then heated to at least the activation temperature of the petcoke; however, in the example shown, the first stage activated blend is heated directly to at least the activation temperature.

Similarly to step 114, step 118 may be carried out under an inert gas such as nitrogen. However, it is possible that a small amount of oxygen may be bled into the system, to promote a small and controlled amount of combustion. This small and controlled amount of combustion may supply heat to step 118, so that step 118 is effectively self heated.

The product of step 118 may be referred to herein as a “second stage activated blend”. The second stage activated blend may generally include activated carbon, potassium hydroxide products, and other reaction by-products. It has been found that the activated carbon that results from step 118 has a microporosity percentage of between about 65% and about 35%, with the remaining pores being mesoporous.

Optionally, the activation process may end after step 118, and the second stage activated blend may be sent to downstream processing steps (e.g. to cool and wash step 120), to yield activated carbon (also referred to herein as double-activated carbon); however, as noted above, further cooling and reheating steps may be carried out (i.e. a third activation stage), in order to allow for the porosity of the activated carbon to be tailored. That is, the second stage activated blend may be cooled to below the activation temperature of the crushed petcoke, and preferably to below the combustion temperature of the petcoke with exposure to air. Then, under substantially inert conditions, the second stage activated blend may be heated to at least the activation temperature of the petcoke, to yield a third-stage activated blend (which includes activated carbon of a third microporosity percentage that is less than the second microporosity percentage).

Upon completion of the activation step (i.e. after a desired number of repetitions of the steps 116 and 118, e.g. up to 5 repetitions), the reaction products (i.e. the first activated blend, or the second activated blend, and so on, depending on the number of repetitions of steps 116 and 118) may be cooled and washed in water (step 118), to yield washed activated carbon. As the starting product (i.e. crushed petcoke) was of a mixture of sizes, the activated carbon will be of a mixture of sizes. The activated carbon may optionally be sieved to separate it by size.

Optionally, potassium hydroxide may be recovered from the wash water, and reused. Further optionally, calcium hydroxide may be added to the wash water, to react with potassium carbonate and form potassium hydroxide and precipitate calcium carbonate as a by-product. The calcium carbonate may be sold, used, or may be stockpiled as sequestered carbon dioxide.

The activated carbon disclosed herein may have a variety of uses, but may be particularly useful in the removal of organic carbon from fluids, such as water (e.g. oil sands process water) or other fluids, such as other fluid effluents or waste streams or other streams. Such fluids may include liquids, gases, liquified gases, or the like. The activated carbon disclosed herein may further be used in the removal of acid gases (e.g. hydrogen sulfide and/or carbon dioxide) from raw natural gas streams.

While the above description provides examples of one or more processes or apparatuses or compositions, it will be appreciated that other processes or apparatuses or compositions may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be re-visited.

The present disclosure describes what are considered to be practical example embodiments. It is recognized, however, that departures may be made within the scope of the invention according to a person skilled in the art. Further, the subject matter of the present disclosure supports and provides sufficient basis for any element, feature, structure, function, and/or step of any aspect, and/or example embodiment described in the present disclosure including the figures, clauses and/or claims herein to be claimed alone in an independent claim and be fully supported herein, or be combined with any other one or more elements, features, structures, functions, and/or steps of any aspect and/or example embodiment described in the present disclosure including the figures, clauses and/or claims herein, as basis for an independent or dependent claim herein.

### EXAMPLES

### Example 1: Preparing and Activating Carbon

### Materials & Methods

Petcoke (Suncor) was ground to an average particle diameter of less than 0.308 mm and pretreated by heating the petcoke at 400° C. under air for 1 hour to remove any volatile compounds. Five grams of the dried petcoke was then mixed with dry potassium hydroxide (Sigma Aldrich, reagent grade) at mass ratios of 0.5:1, 1:1, 2:1 and 3:1 (KOH:Petcoke). The mixture was placed in stainless steel crucibles and heated to 400° C. under nitrogen and held at that temperature for 30 minutes to melt the potassium hydroxide, thereby increasing contact with the petcoke. It is believed that in this step, at least some of the potassium hydroxide is converted to potassium oxide. The samples were then activated by heating the sample under nitrogen to temperatures varying between 800° C. and 950° C. Samples were held at these temperatures for 15 minutes unless otherwise specified. Samples were then either washed with water or put through additional activation stages, as described below. The washing process consisted of 20 mL of water per gram of unwashed activated product.

Additional activation stages involved allowing the product to cool to room temperature under nitrogen, exposing the product to air with grinding (to increase mixing), and then reheating the material at 400° C. for 30 minutes, followed by an additional heating step in which the samples were heated to a temperature of 900° C. for up to 30 minutes under nitrogen, unless otherwise stated (see Table 1). The samples were then either put through the washing procedure or put through additional activation stages.

All Raman spectra were acquired using a Renishaw in Via Raman Microscope with 633 nm excitation and an 1800 line/mm diffraction grating. Laser power at the source was 100 mW. Typically, 10 scans were co-added to achieve appropriate signal to noise in the range of 1100 to 1800 cm⁻¹. The disorder (D-peak) and graphitic peak (G-Peak) at 1300 cm⁻¹ and 1650 cm⁻¹ respectively was deconvoluted using Origin graphical software. The area under the G-peak and the area under the D-peaks were obtained for each specific activation (singly, doubly, or triply activated) and ratio (1:1 or 2:1 KOH to petroleum coke derived activated carbon) combination. These values were then divided by each other. This was done in triplicate for each activation and ratio combinations. The G/D peak ratios for each combination were averaged and graphed to determine if there was a trend in the G/D peak ratios.

Surface area and pore size analysis was done using the Tristar II plus. The samples were analyzed using N₂ adsorption at 77 K with 50 points monitoring adsorption between 0.0065 p/p⁰ and 0.995 p/p⁰ and 52 points desorption between 0.995 p/p⁰ and 0.104 p/p⁰. Some samples were additionally investigated using CO₂ adsorption at 273 K. All surface areas are reported using Brunauer-Emmet-Teller surface area analysis with pore size distributions developed using DFT with slit geometry modeling 2D-NLDFT with N₂ carbon finite pores.

### Results

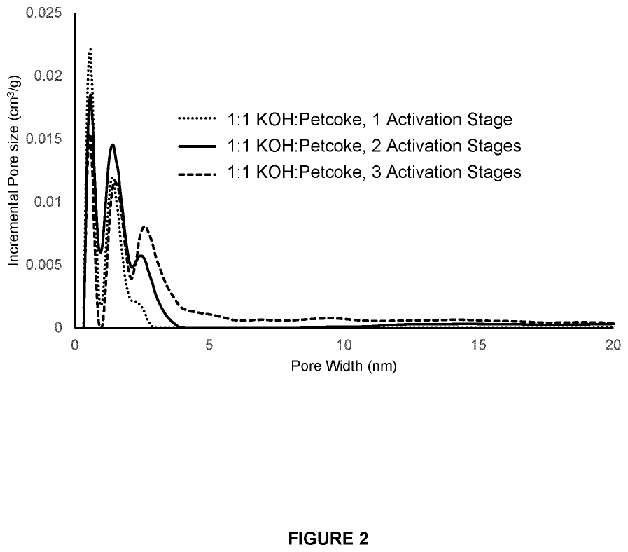

FIG. 2 shows the incremental pore size distribution of samples activated at a ratio of 1:1 KOH:petcoke, going through 1, 2 and 3 activation stages to 900° C. FIG. 2 indicates that additional activation stages result in pore widening. It is believed that the additional activation stages result in the introduction of oxygen and/or humidity to the potassium products trapped within the existing pores, which allows for remaining potassium to convert back to potassium hydroxide. It is further believed that additional activation stages result in the expansion of products within the pores, which in turn cracks and hollows out the pores further leading to an increase in mesoporosity and a shift of the porosity to the right in FIG. 2. While the peak at 0.65 nm is reduced with each subsequent activation stage, the peaks at 1.5 nm and 2.7 broaden and increase in intensity.

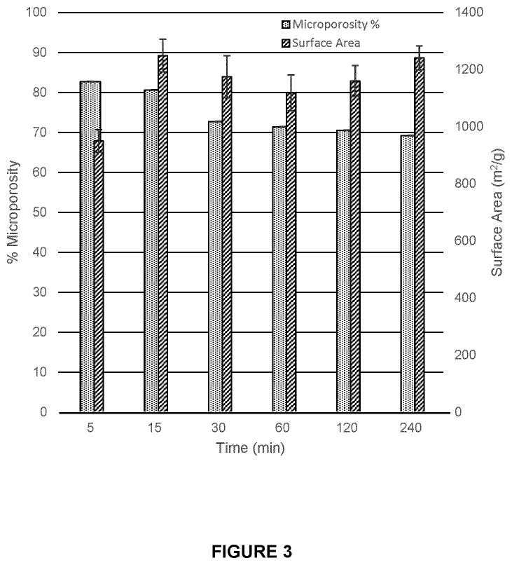

Table 1 shows that the surface area for a 1:1 mass ratio of KOH:petcoke remains relatively constant over additional activation stages. Table 1 further shows that the activated carbon goes from being about 75% microporous after the first activation stage, to about 61% microporous after the second activation stage, and to about 37% after the third activation stage. This is different from the processes in which the potassium hydroxide and petcoke were heated to at or above the activation temperature only once (i.e. a single activation stage), but for a relatively long retention time. As shown in FIG. 3, a single activation stage, even for retention times of up to 240 minutes, resulted in only about a 10% decrease in microporosity. Thus, it is believed that the effect of cooling and reheating to at least the activation temperature that results in the decreased microporosity and increased mesoporosity, and not the increased total time for which the potassium hydroxide and petcoke are heated to at least the activation temperature.

The drop in microporosity seen in Table 1 is believed to be the result of a widening of the pores and not the introduction of new porosity. This trend of shifting porosity towards being mesoporous is seen for all ratios of potassium hydroxide to petcoke.

TABLE 1

| Temperature | | | Retention | Total | | | | Surface | | |
|---|---|---|---|---|---|---|---|---|---|---|
| (° C.) of | | Number of | Time of 1^{st} | Activation | | % | Surface | Area | | % |
| Activation | Ratio | Activation | Activation | time | % | Yield | Area | STDEV | % | Microporosity |
| Steps | KOH:Petcoke | Steps | Step | (min) | Yield | (STDEV) | (m²/g) | (m²/g) | Microporosity | STDEV |
| 900 | 0.5:1 | 1 | 15 | 15 | 68 | 1.7 | 472 | 5 | 68.5 | 2.0 |
| 900 | 0.5:1 | 2 | 15 | 15 | 49 | 3 | 375 | 36 | 50.3 | 4.1 |
| 900 | 1:1 | 1 | 15 | 15 | 71 | 0.6 | 1059 | 75 | 74.9 | 2.3 |
| 900 | 1:1 | 2 | 15 | 30 | 57 | 1.6 | 1103 | 37 | 60.6 | 0.2 |
| 900 | 1:1 | 3 | 15 | 45 | 40 | 1.8 | 986 | 27 | 36.5 | 2.1 |
| 900 | 2:1 | 1 | 15 | 15 | 56 | 3 | 1618 | 202 | 75.3 | 2.8 |
| 900 | 2:1 | 2 | 15 | 30 | 45 | 1 | 2032 | 102 | 49.9 | 4.8 |
| 900 | 2:1 | 3 | 15 | 45 | 28 | 1 | 1883 | 90 | 36.7 | 1.4 |
| 900 | 3:1 | 1 | 15 | 15 | 39 | 6 | 2143 | 15 | 45.8 | 2.5 |
| 900 | 3:1 | 2 | 15 | 30 | 26 | 2 | 2148 | 93 | 37.4 | 8.7 |
| 900 | 3:1 | 3 | 15 | 45 | 12 | 4 | 1923 | 95 | 21.6 | 1.7 |

Table 2 shows the effect of retention time on surface area and pore size distribution.

TABLE 2

| Temperature | | | Retention | Total | | | | Surface | | |
|---|---|---|---|---|---|---|---|---|---|---|
| (° C.) of | | Number of | Time of 1^{st} | Activation | | % | Surface | Area | | % |
| Activation | Ratio | Activation | Activation | time | % | Yield | Area | STDEV | % | Microporosity |
| Stages | KOH:Petcoke | Stages | Stage | (min) | Yield | (STDEV) | (m²/g) | (m²/g) | Microporosity | STDEV |
| 900 | 0.5:1 | 1 | 30 | 30 | 66 | 2 | 359 | 35 | 70.5 | 2.4 |
| 900 | 0.5:1 | 2 | 30 | 60 | 45 | 4 | 418 | 6 | 54.9 | 4.4 |
| 900 | 1:1 | 1 | 30 | 30 | 64 | 3 | 1217 | 25 | 76.6 | 0.2 |
| 900 | 1:1 | 2 | 30 | 60 | 48 | 1 | 1167 | 25 | 56.9 | 2.3 |
| 900 | 1:1 | 3 | 30 | 90 | 34 | 1 | 1084 | 238 | 38.8 | 2.0 |

Tables 1 and 2 show that there is a drop in yield with each successive activation step. Furthermore, a longer retention time in each activation step results in a further drop in yield. Due to this yield loss, activation stages at lower temperatures were conducted. Results of the activation stages at lower temperatures are shown in Table 3.

TABLE 3

| Temperature | | | Temperature | Retention | | | | | | | |
|---|---|---|---|---|---|---|---|---|---|---|---|
| (° C.) of | | | (° C.) of | Time of 1^{st} | Total | | | | Surface | | % |
| First | | Number of | Subsequent | Activation | Activation | | % | Surface | Area | % | Micro- |
| Activation | Ratio | Activation | Activation | Stage | time | % | Yield | Area | (STDEV) | Micro- | porosity |
| Stage | KOH:Petcoke | Steps | Stages | (min) | (min) | Yield | (STDEV) | (m²/g) | (m²/g) | porosity | (STDEV) |
| 900 | 1:1 | 1 | 900 | 15 | 15 | 71 | 0.6 | 1059 | 75 | 74.9 | 2.3 |
| 900 | 1:1 | 2 | 900 | 15 | 30 | 57 | 1.6 | 1103 | 37 | 60.6 | 0.2 |
| 900 | 1:1 | 3 | 900 | 15 | 45 | 40 | 1.8 | 986 | 27 | 36.5 | 2.1 |
| 900 | 1:1 | 2 | 800 | 15 | 30 | 53 | 1.8 | 1034 | 88 | 61.8 | 3.2 |
| 900 | 1:1 | 3 | 800 | 15 | 45 | 41 | 2.8 | 733 | n/a | 49.9 | 1.1 |
| 900 | 1:1 | 2 | 700 | 15 | 30 | 61 | 1.3 | 930 | n/a | 74.5 | 1.2 |
| 900 | 1:1 | 2 | 600 | 15 | 30 | 61 | 0.8 | 815 | 17 | 74.4 | 1.6 |

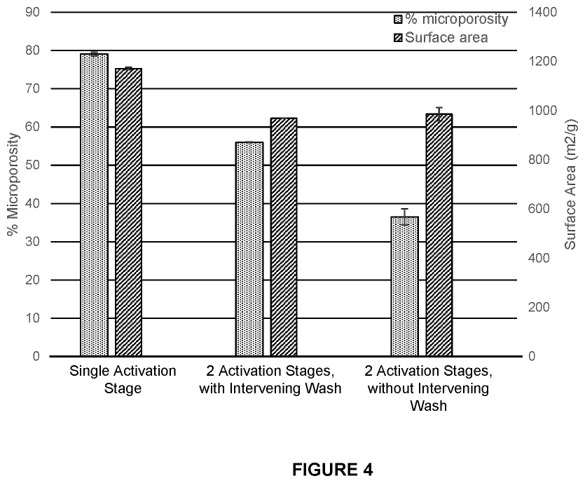

FIG. 4 shows that samples that were washed after the first activation stage and then subjected to successive activation stages showed some pore widening, with an increase in mesoporosity of 23.1%. This is compared to an increase in mesoporosity of 42.6% in the product that was not washed between the first and second activation stages.

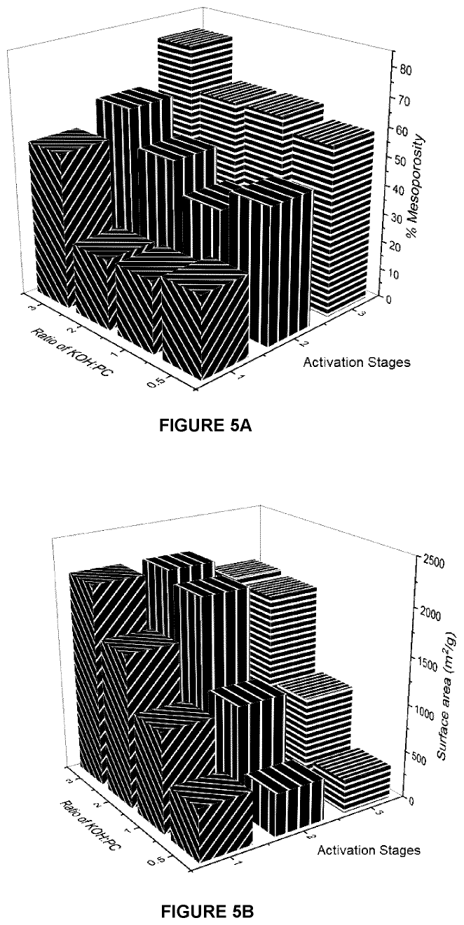

FIG. 5A shows the relationship between the ratio of KOH to petcoke (PC), the number of activation stages, and the percent mesoporosity. Percent mesoporosity increases with increased activation stages. The percent mesoporosity also increases with increasing KOH:petcoke, but only at the highest ratio. FIG. 5B shows the relationship between the ratio of KOH to petcoke (PC), the number of activation stages, and surface area. Surface area increases with increasing KOH:petcoke. The number of activation stages had a limited impact on the surface area.

### Example 2: Effect of Increased Mesoporosity on Kinetics of Adsorption

### Materials & Methods

Three adsorption kinetic experiments were carried out using a model naphthenic acid, diphenyl acetic acid (DPA) on three separate activated carbons: activated carbon prepared from 1:1 KOH:Petcoke, and subjected to one, two, or three activation stages of 15 minutes each at 900 degrees Celsius, as described above. Each activated carbon was sieved to a size between 0.1 mm to 0.3 mm to compare the same size fraction. The procedure involved using a 40-ppm solution of DPA buffered to a pH of approximately 8-8.5 using a 0.01 M phosphate buffer. Batch adsorption experiments were carried out for time points from 5 minutes to 48 hrs, all in triplicate, using 100 mL of DPA solution mixed with 50 mg±0.5 mg of activated carbon, along with an accompanied 100 mL volume of DPA solution without any AC. Samples were mixed on a Thermo Scientific shaker table at 200 rpm in sealed glass beakers and filtered into TOC sample vials using 0.45 um syringes. All samples were then analyzed by a Shimadzu TOC VCPH analyzer using NPOC analysis.

### Results and Discussion

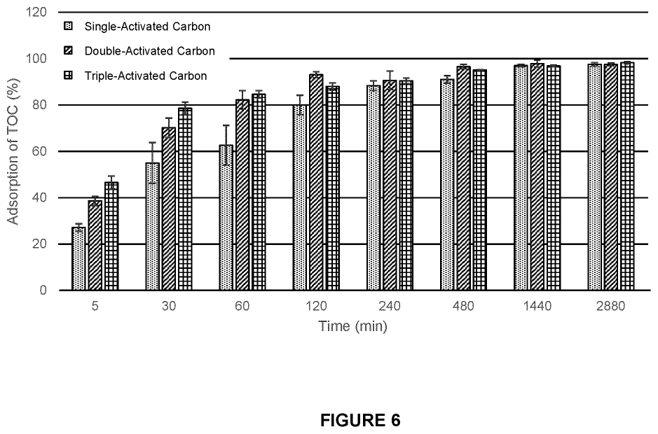

FIG. 6 shows the adsorption kinetics of DPA over time onto single-, double- and triple-activated carbon. FIG. 6 shows that significantly faster initial adsorption kinetics can be observed for the first 30 minutes of adsorption for the triple-activated carbon relative to both the single- and double-activated carbon. By the 60 minute mark, both the double- and triple-activated carbon appear to be adsorbing at the same rate, however the single-activated carbon continues to achieve a lower percentage of adsorption relative to the double and triple activated carbon up until the 1440 minute mark, at which point all three activated carbons appear to achieve the same level of adsorption. All three activated carbons achieve the same max adsorption at equilibrium of approximately 98%.

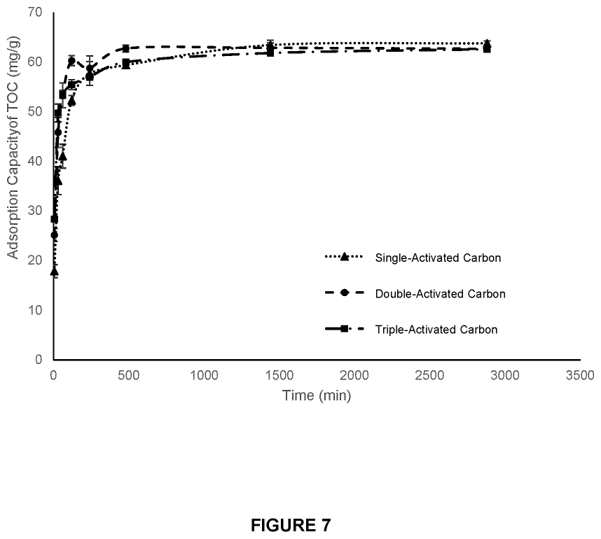

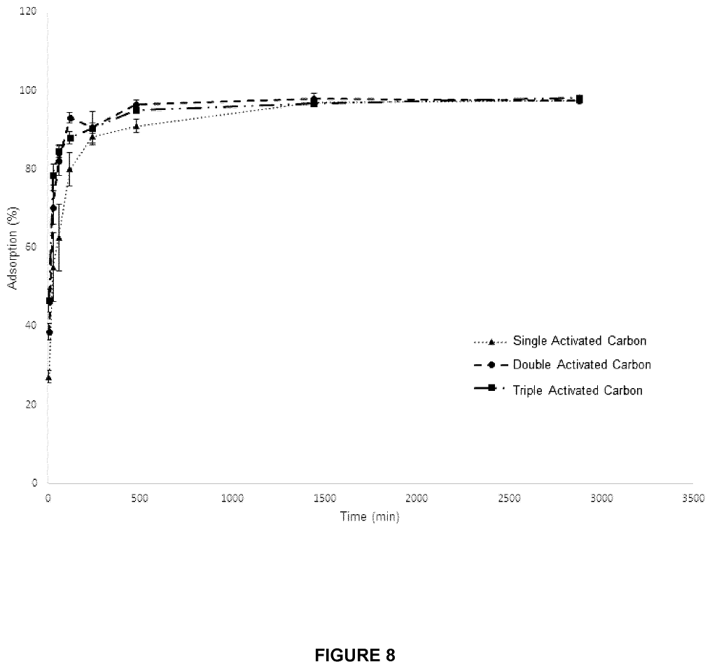

FIG. 7 shows the adsorption kinetic curves of DPA onto single-, double-, and triple-activated carbon, normalized based on mg/g. FIG. 8 shows the adsorption kinetic curves of DPA onto single-, double-, and triple-activated carbon, normalized based on % adsorption.

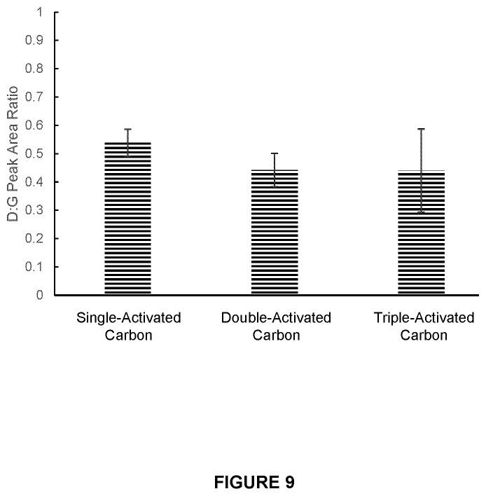

FIG. 9 is a graph showing the ratio of the fitted D to G peak areas from the Raman spectrum of an activated carbon sample. The ratio of the g-peak to the d-peak goes down with each subsequent activation stage, suggesting that there is an increase in the ratio of disorder to that of graphite within the activated carbon with each activation stage.

While the triple-activated carbon appears to have a slightly lower surface area of 986±27 m²/g, both the single and double activated carbon have nearly synonymous total surface area of approximately 1059±75 and 1103±37 m²/g respectively (Table 1). However, the most significant difference between the surface characteristics of these three activated carbons is the distribution of porosity, with the single-, double-, and triple-activated carbons having a percentage of microporosity of 74.9±2.3, 60.6±0.2, and 36.5±2.1 respectively (Table 1). The differences observed in DPA adsorption kinetics are consistent with the reduction in microporosity/increase in mesoporosity identified in the single-, double-, and triple-activated carbons, as increased mesoporosity is expected to help improve the internal diffusion of DPA within activated carbon to reach the microporous space where adsorption predominately takes place. Additionally, the nearly same total surface area observed within each activated carbon likely explains why all three activated carbons achieve the same max adsorption of DPA at equilibrium.

### Example 2: Use of Activated Carbon for Removal of Organics from Oil Sands Process Water (OSPW)

### Materials and Methods

100 mL of oil sands processed water (OSPW) was mixed with 0.1 g of either single activated carbon or triple activated carbon (prepared as described above) on an orbital shaker table at 200 rpm for various times. OSPW had a pH of 8.33. Samples were then filtered with 0.1 micron filters to remove activated carbon and silicates from solution for non-purgeable organic carbon analysis (NPOC). NPOC content was measured using a SHIMADZU TOC-V total organic carbon analyzer with TOC-Control V version 2.60 software.

To study the effect of particle size on OSPW adsorption, triple-activated carbon (prepared as described above) was sieved. The first sized AC was between mesh 40 OPN (1.0160 mm) and mesh 041 OPN (0.1041 mm). The second sized AC was less than mesh 041 OPN (0.1041 mm). These sized AC's were then tested for their adsorption of OSPW NPOC, as described above.

### Results and Discussion

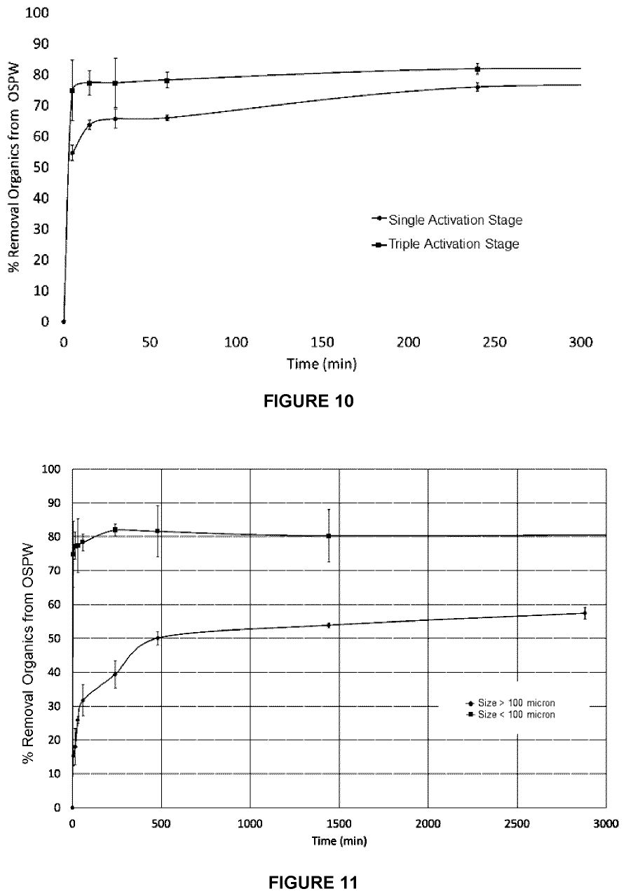

FIG. 10 shows improvement in % organic removal from oil sands process water (OSPW) using single activated carbon versus triple activated carbon. Both the extent of adsorption and the kinetics of the adsorption are larger for the triple activated carbon.

FIG. 11 shows the enhanced efficacy and kinetics of adsorption of organics from oil sands process water (OSPW) when the particle size of the activated carbon is smaller. In this case the % organics adsorbed from OSPW is over 80% using activated carbon with a particle size smaller than 100 microns, whereas the adsorption is significantly reduced for larger activated carbon particles (larger than 100 microns).

### Clauses

Non-limiting examples are described in the following clauses:

1. A process for preparing a carbon source for activation, comprising:
a. combining a crushed carbonized carbon source with an alkali hydroxide, wherein the alkali hydroxide is in a non-aqueous state; and
b. heating the crushed carbonized carbon source and the alkali hydroxide to a sub-activation temperature to yield a pre-activated blend, wherein the sub-activation temperature is at or above a melting point of the alkali hydroxide and below an activation temperature of the crushed carbonized carbon source.

2. The process of any of the preceding or following clauses, wherein the crushed carbonized carbon source has a particle size of at most 8 mesh.

3. The process of any of the preceding or following clauses, wherein the crushed carbonized carbon source comprises at least one of a petroleum coke, a lignite coal, an anthracite coal, a metallurgical coal, and a bottom boiler ash.

4. The process of any of the preceding or following clauses, wherein the crushed carbonized carbon source comprises petroleum coke.

5. The process of any of the preceding or following clauses, wherein the alkali hydroxide comprises potassium hydroxide.

6. The process of any of the preceding or following clauses wherein in step a., the alkali hydroxide is in the form of potassium hydroxide pellets.

7. The process of any of the preceding or following clauses, wherein the sub-activation temperature is between 360 degrees Celsius and 750 degrees Celsius.

8. The process of any of the preceding or following clauses, wherein step b. is carried out under ambient air and the sub-activation temperature is between 360 degrees Celsius and 550 degrees Celsius.

9. The process of any of the preceding or following clauses, wherein in step b., the sub-activation temperature is maintained for a retention time of at least 15 minutes.

10. The process of any of the preceding or following clauses, wherein in step b., the sub-activation temperature is maintained for a retention time of between 15 minutes and 30 minutes.

11. The process of any of the preceding or following clauses, wherein the crushed carbonized carbon source and the alkali hydroxide are combined in a mass ratio of between 0.5:1 and 3:1 alkali hydroxide:crushed carbonized carbon source.

12. The process of any of the preceding or following clauses, wherein the crushed carbonized carbon source and the alkali hydroxide are combined in a mass ratio of about 1:1 alkali hydroxide:crushed carbonized carbon source.

13. A product made by the process of any of the preceding or following clauses.

14. A process for activating carbon, comprising:
a. under substantially inert conditions, heating a blend of a crushed carbonized carbon source and a non-aqueous alkali hydroxide product to at least an activation temperature of the crushed carbonized carbon source, to yield a first-stage activated blend, wherein the first stage activated blend comprises activated carbon of a first microporosity percentage;
b. after step a., cooling the first stage activated blend to below the activation temperature of the crushed carbonized carbon source;
c. after step b., under substantially inert conditions, heating the first stage activated blend to at least the activation temperature of the crushed carbonized carbon source to yield a second-stage activated blend, wherein the second stage activated blend comprises activated carbon of a second microporosity percentage that is less than the first microporosity percentage.

15. The process of any of the preceding or following clauses, further comprising, after step c., washing the second-stage activated blend.

16. The process of any of the preceding or following clauses, further comprising:
d. cooling the second stage activated blend to below the activation temperature of the crushed carbonized carbon source; and
e. after step d., under substantially inert conditions, heating the second stage activated blend to at least the activation temperature of the crushed carbonized carbon source to yield a third-stage activated blend, wherein the third stage activated blend comprises activated carbon of a third microporosity percentage that is less than the second microporosity percentage.

17. The process of any of the preceding or following clauses, wherein step a. is carried out under nitrogen gas.

18. The process of any of the preceding or following clauses, wherein in step a., oxygen is bled into the nitrogen gas.

19. The process of any of the preceding or following clauses, wherein in step b., the first stage activated blend is cooled to below a combustion temperature of the crushed carbonized carbon source.

20. The process of any of the preceding or following clauses, wherein step b. further comprises, after cooling the first stage activated blend to below the combustion temperature of the crushed carbonized carbon source, exposing the first stage activated blend to ambient air.

21. The process of any of the preceding or following clauses, wherein the first stage activated blend is maintained below the combustion temperature of the crushed carbonized carbon source and exposed to air for up to 72 hours.

22. The process of any of the preceding or following clauses, wherein in step b., the first stage activated blend is cooled to between 200 degrees Celsius and 250 degrees Celsius.

23. The process of any of the preceding or following clauses, wherein in step a., the crushed carbonized carbon source and the non-aqueous alkali hydroxide product are maintained at at least the activation temperature for between 7 minutes and 60 minutes.

24. The process of any of the preceding or following clauses, wherein in step a., the crushed carbonized carbon source and the non-aqueous alkali hydroxide product are maintained at at least the activation temperature for between 7 minutes and 30 minutes.

25. The process of any of the preceding or following clauses, wherein in step c., the first stage activated blend is maintained at at least the activation temperature for between 7 minutes and 30 minutes.

26. The process of any of the preceding or following clauses, wherein in step a., the crushed carbonized carbon source and the non-aqueous alkali hydroxide product are heated to between 750 degrees Celsius and 900 degrees Celsius.

27. The process of any of the preceding or following clauses, further comprising, prior to step a.:
i. combining the crushed carbonized carbon source with an alkali hydroxide, wherein the alkali hydroxide is in a non-aqueous state; and
ii. heating the crushed carbonized carbon source and the alkali hydroxide to a sub-activation temperature to yield a pre-activated blend, wherein the sub-activation temperature is at or above a melting point of the alkali hydroxide and below an activation temperature of the crushed carbonized carbon source, and wherein the pre-activated blend comprises the crushed carbonized carbon source and the alkali hydroxide product.

28. A product made by the process of any of the preceding or following clauses.

29. A process for preparing and activating carbon, comprising:
a. combining crushed petroleum coke with potassium hydroxide, wherein the potassium hydroxide is in a non-aqueous state;
b. after step a., heating the crushed petroleum coke and the potassium hydroxide to a sub-activation temperature to yield a pre-activated blend, wherein the sub-activation temperature is at or above a melting point of the potassium hydroxide and below an activation temperature of the crushed carbonized carbon source;
c. after step b., under substantially inert conditions, heating the pre-activated blend to at least the activation temperature of the crushed carbonized carbon source to yield a first-stage activated blend, wherein the first stage activated blend comprises activated carbon of a first microporosity percentage;
d. after step c., cooling the first stage activated blend to below the activation temperature of the crushed carbonized carbon source; and
e. after step d., under substantially inert conditions, heating the first stage activated blend to at least the activation temperature of the crushed carbonized carbon source to yield a second-stage activated blend, wherein the second stage activated blend comprises activated carbon of a second microporosity percentage that is less than the first microporosity percentage.

30. An activated carbon as described herein.

31. A process as described herein.

32. A product made by the process of any of the preceding clauses.

33. A use of the product of the process of any of the preceding clauses to remove organic carbon from water.

34. A use of the product of the process of any of the preceding clauses to remove organic carbon from at least one fluid.

35. The use of any of the preceding or following clauses, wherein the at least one fluid includes at least one liquid, gas, or liquified gas.

36. The use of any of the preceding clauses, wherein the at least one fluid is an effluent, a waste stream and/or another stream.

37. A use of the product of the process of any of the preceding clauses to remove at least one acid gas from at least one raw natural gas stream.

38. The use of any of the preceding clauses, wherein the at least one acid gas includes hydrogen sulfide and/or carbon dioxide.

1. A process for preparing a carbon source for activation, comprising:
a. combining a crushed carbonized carbon source with an alkali hydroxide, wherein the alkali hydroxide is in a non-aqueous state; and
b. heating the crushed carbonized carbon source and the alkali hydroxide to a sub-activation temperature to yield a pre-activated blend, wherein the sub-activation temperature is at or above a melting point of the alkali hydroxide and below an activation temperature of the crushed carbonized carbon source.

2. The process of claim 1, wherein the crushed carbonized carbon source has a particle size of at most 8 mesh.

3. The process of claim 1, wherein the crushed carbonized carbon source comprises at least one of a petroleum coke, a lignite coal, an anthracite coal, a metallurgical coal, and a bottom boiler ash.

4. The process of claim 1, wherein the crushed carbonized carbon source comprises petroleum coke.

5. The process of claim 1, wherein the alkali hydroxide comprises potassium hydroxide.

6. The process of claim 1, wherein in step a., the alkali hydroxide is in the form of potassium hydroxide pellets.

7. The process of claim 1, wherein the sub-activation temperature is between 360 degrees Celsius and 750 degrees Celsius.

8. The process of claim 1, wherein step b. is carried out under ambient air and the sub-activation temperature is between 360 degrees Celsius and 550 degrees Celsius.

9. The process of claim 1, wherein in step b., the sub-activation temperature is maintained for a retention time of at least 15 minutes.

10. The process of claim 1, wherein in step b., the sub-activation temperature is maintained for a retention time of between 15 minutes and 30 minutes.

11. The process of claim 1, wherein the crushed carbonized carbon source and the alkali hydroxide are combined in a mass ratio of between 0.5:1 and 3:1 alkali hydroxide:crushed carbonized carbon source.

12. The process of claim 1, wherein the crushed carbonized carbon source and the alkali hydroxide are combined in a mass ratio of about 1:1 alkali hydroxide:crushed carbonized carbon source.

13. A product made by the process of claim 1.

14. A process for activating carbon, comprising:
a. under substantially inert conditions, heating a blend of a crushed carbonized carbon source and a non-aqueous alkali hydroxide product to at least an activation temperature of the crushed carbonized carbon source, to yield a first-stage activated blend, wherein the first stage activated blend comprises activated carbon of a first microporosity percentage;
b. after step a., cooling the first stage activated blend to below the activation temperature of the crushed carbonized carbon source;
c. after step b., under substantially inert conditions, heating the first stage activated blend to at least the activation temperature of the crushed carbonized carbon source to yield a second-stage activated blend, wherein the second stage activated blend comprises activated carbon of a second microporosity percentage that is less than the first microporosity percentage.

15. The process of claim 14, further comprising, after step c., washing the second-stage activated blend.

16. The process of claim 14, further comprising:
d. cooling the second stage activated blend to below the activation temperature of the crushed carbonized carbon source; and
e. after step d., under substantially inert conditions, heating the second stage activated blend to at least the activation temperature of the crushed carbonized carbon source to yield a third-stage activated blend, wherein the third stage activated blend comprises activated carbon of a third microporosity percentage that is less than the second microporosity percentage.

17. The process of claim 14, wherein step a. is carried out under nitrogen gas.

18. The process of claim 17, wherein in step a., oxygen is bled into the nitrogen gas.

19. The process of claim 14, wherein in step b., the first stage activated blend is cooled to below a combustion temperature of the crushed carbonized carbon source.

20. The process of claim 19, wherein step b. further comprises, after cooling the first stage activated blend to below the combustion temperature of the crushed carbonized carbon source, exposing the first stage activated blend to ambient air.

21. The process of claim 19, wherein the first stage activated blend is maintained below the combustion temperature of the crushed carbonized carbon source and exposed to air for up to 72 hours.

22. The process of claim 14, wherein in step b., the first stage activated blend is cooled to between 200 degrees Celsius and 250 degrees Celsius.

23. The process of claim 14, wherein in step a., the crushed carbonized carbon source and the non-aqueous alkali hydroxide product are maintained at at least the activation temperature for between 7 minutes and 60 minutes.

24. The process of claim 14, wherein in step a., the crushed carbonized carbon source and the non-aqueous alkali hydroxide product are maintained at at least the activation temperature for between 7 minutes and 30 minutes.

25. The process of claim 14, wherein in step c., the first stage activated blend is maintained at at least the activation temperature for between 7 minutes and 30 minutes.

26. The process of claim 14, wherein in step a., the crushed carbonized carbon source and the non-aqueous alkali hydroxide product are heated to between 750 degrees Celsius and 900 degrees Celsius.

27. The process of claim 14, further comprising, prior to step a.:
i. combining the crushed carbonized carbon source with an alkali hydroxide, wherein the alkali hydroxide is in a non-aqueous state; and
ii. heating the crushed carbonized carbon source and the alkali hydroxide to a sub-activation temperature to yield a pre-activated blend, wherein the sub-activation temperature is at or above a melting point of the alkali hydroxide and below an activation temperature of the crushed carbonized carbon source, and wherein the pre-activated blend comprises the crushed carbonized carbon source and the alkali hydroxide product.

28. A product made by the process of claim 14.

29. A process for preparing and activating carbon, comprising:
a. combining crushed petroleum coke with potassium hydroxide, wherein the potassium hydroxide is in a non-aqueous state;
b. after step a., heating the crushed petroleum coke and the potassium hydroxide to a sub-activation temperature to yield a pre-activated blend, wherein the sub-activation temperature is at or above a melting point of the potassium hydroxide and below an activation temperature of the crushed carbonized carbon source;
c. after step b., under substantially inert conditions, heating the pre-activated blend to at least the activation temperature of the crushed carbonized carbon source to yield a first-stage activated blend, wherein the first stage activated blend comprises activated carbon of a first microporosity percentage;
d. after step c., cooling the first stage activated blend to below the activation temperature of the crushed carbonized carbon source; and
e. after step d., under substantially inert conditions, heating the first stage activated blend to at least the activation temperature of the crushed carbonized carbon source to yield a second-stage activated blend, wherein the second stage activated blend comprises activated carbon of a second microporosity percentage that is less than the first microporosity percentage.

30. (canceled)

31. (canceled)

32. A product made by the process of claim 29.

33.-38. (canceled)
